(19) United States
(12) Patent Application Publication
(10) Pub. No.: US 2018/0373405 A1
(43) Pub. Date: Dec. 27, 2018

(54) TARGETED INTEREST AND CONTENT SHARING PLATFORMS

(71) Applicant: MICROSOFT TECHNOLOGY LICENSING, LLC, Redmond, WA (US)

(72) Inventors: Ryder Puueo DONAHUE, Kirkland, WA (US); Anthony GALLIANO, III, Seattle, WA (US); Justin Shane McROBERTS, Seattle, WA (US); Robert Earl GARLAND, Redmond, WA (US); Nicholas Jie FANG, Redmond, WA (US); William Alden MAYNES, Bellevue, WA (US)

(21) Appl. No.: 15/635,139

(22) Filed: Jun. 27, 2017

(51) Int. Cl. G06F 3/0484; H04L 29/06; G06F 3/14; G06F 17/30; A63F 13/87; A63F 13/25; A63F 13/86; A63F 13/30

(52) U.S. Cl. CPC G06F 3/0484; H04L 65/403; G06F 3/1454; G06F 17/30029; A63F 13/30; G06F 17/30867; A63F 13/87; A63F 13/25; A63F 13/86; G06F 17/3005

(57) ABSTRACT

Techniques for sharing content across groupings of users sharing a common topic of interest are provided. A subgroup of users from a plurality of users can be identified based on contextual information indicating the common topic of interest. The subgroup of users can access a common user interface generated with a media server that allows interaction between the subgroup of users. New media content can be automatically chosen in an intelligent manner based on user activity related to currently shared content, and other media content can also be chosen by, and confirmed by, individual users of the subgroup of users. New content can also be selected and displayed in response to threshold levels of user activity. The common user interface and automatic presentation of new content allows for an immersive experience across a plurality of platforms.

### BACKGROUND

Currently, spaces for online communities with shared interests rely on shared text-based chats, shared voice-based chats, shared activity “feeds,” and other social or “blog” style interactions between users. For example, with regard to sharing a particular piece of media content, an online community of participants may generate messages on a blog displaying that particular piece of media content.

### SUMMARY

The techniques disclosed herein provide a rich and consistent experience for users engaged in sharing media content related to a particular topic of interest. This disclosure describes systems, methods, user interfaces, and computer-readable media for updating, transmitting, retrieving, and displaying shared media content, on any of a number of platforms, computing devices, mobile devices, and/or gaming consoles. Among many other benefits, the techniques herein improve efficiencies with respect to a wide range of computing resources. For instance, human interaction with a device may be improved as the use of the techniques disclosed herein enable a user to view a wide range of shared content while accessing a common user interface. In addition, improved human interaction provides improvements among other computing resources such as processor and network resources. For example, users can stay on the common user interface and reduce interaction, traffic of transferred media, and compute cycles. Improved interaction can also reduce the number of inadvertent inputs. In addition, the techniques disclosed herein allow for a more computationally efficient way (e.g., more efficient by reducing memory usage and computing bandwidth) to identify and control grouping of individuals and media content available to users of an identified subgroup. A media server may directly access common topics of interest associated with subgroups of users and therefore quickly and efficiently create online communities for access to the common user interface. Other technical effects other than those mentioned herein can also be realized from implementations of the technologies disclosed herein.

In some configurations, the techniques disclosed herein can automatically select groups of users sharing a common interest. A system can then automatically display new pieces of desirable content that are relevant to communities having shared interests. The techniques disclosed herein can improve user interaction with one or more computers and computing services by maintaining user engagement in response to one or more conditions. In some configurations, a system can monitor user activity associated with media content. When the user activity falls below a threshold, the system can suggest and automatically display new media content across groups, sub-group, and public forums.

According to one implementation, a method of content sharing can include a step of determining a subgroup of users of a plurality of users associated with a common topic of interest. Additionally, the determining step can be facilitated through comparison of various user data to determine users of the plurality of users, e.g., a subset or subgroup of users, that share the common topic of interest.

The method can also include a step of identifying media content associated with the subgroup of users and the common topic of interest. For example, the identifying step can include searching a database of shareable content to determine media content associated with the common topic of interest. Thereafter, the method can include a step of providing a display of the shareable content to at least one user of the subgroup of users and receiving affirmation, or a confirmation by one or more users, to display the shareable content. Alternatively, the identifying step can also include searching a database of shareable content to determine media content associated with the common topic of interest and the contextual data associated with the subgroup of users.

The method can also include a step of generating a common user interface. The common user interface can be configured to cause computing devices to display the identified media content and communications between the subgroup of users and associated with the identified media content. Thereafter, the method can include a step of sharing the common user interface with at least the subgroup of users. Accordingly, the subgroup of users can utilize the shared common user interface to interact with one another and view the identified media content. Thus, implementations may overcome previous drawbacks by allowing a subgroup of users to interact with identified content related to a common topic of interest. The identified content can be periodically refreshed to establish additional opportunities for user interaction.

According to another implementation, a method of content sharing can include determining a sub-group of user identities from a plurality of user identities. The sub-group of user identities can be associated with users having at least one common topic of interest. Additionally, the determining can be facilitated through comparison of various user data to determine which users of the plurality of users share the common topic of interest.

The method can further include a step of sharing media content across the sub-group of user identities and sharing chat content associated with the sub-group of user identities. The media content can be related to the common topic of interest. Furthermore, the chat content can include text, video, and/or audio information provided by individual users of the subgroup of user identities related to the currently shared media content.

Generally, the sharing of media content and chat content can be examined to determine an activity level or interest level in the presently shared media content and/or chat content. The method can also include determining when activity associated with the media content or chat content is below a threshold. Thus, through examining the shared chat content, the technologies disclosed herein can further determine when the shared media content should be refreshed or when new content should be shared to increase a level of interest in the content sharing platform.

Accordingly, in response to determining that the activity is below the threshold, the method can also include a step of suggesting or automatically displaying new media content across the sub-group of user identities. The suggestion or automatic display can be based at least in part upon the at least one common topic of interest and contextual data for one or more user identities of the sub-group of user identities.

According to another implementation, a method of content sharing can include a step of determining a subgroup of users of a plurality of users associated with a common topic of interest. For example, the subgroup of users can be determined as outlined above.

The method can further include a step of generating a common user interface. The common user interface can cause computing devices to display media content and communications between the subgroup of users. Subsequently, or at substantially the same time, the method can include a step of receiving media content from at least one user of the subgroup of users and associated with the common topic of interest. The media content can include various media types, forms, and content, and may be received directly from a computing device or media content server configured to store media content.

The method further includes a step of sharing the common user interface and received media content with at least the subgroup of users. The shared common user interface may be subsequently updated with new media content provided by users of the subgroup of users. Furthermore, the updated common user interface can be refreshed to allow continued communication and sharing of chat, media content, and other interactions between users of the subgroup of users.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a diagram illustrating an example operating environment in which one or more systems can operate to facilitate content sharing.

FIG. 2 is a diagram illustrating an example operating environment in which one or more groupings of users can receive and interact with shared content.

FIG. 3 is a diagram of an example common user interface for content sharing, according to the techniques and technologies disclosed herein.

FIG. 4 is a flow diagram of a method of providing content sharing between subgroups of users, according to the techniques and technologies disclosed herein.

FIG. 5 is a flow diagram of a method of providing content sharing based on an activity threshold, according to the techniques and technologies disclosed herein.

FIG. 6 is a computer architecture diagram illustrating a computing device architecture for a computing device capable of implementing aspects of the techniques and technologies presented herein.

### DETAILED DESCRIPTION

The techniques disclosed herein provide a rich and consistent experience for users engaged in sharing media content related to a particular topic of interest. This disclosure describes systems, methods, user interfaces, and computer-readable media for updating, transmitting, retrieving, and displaying shared media content, on any of a number of platforms, computing devices, mobile devices, and/or gaming consoles.

Currently, spaces for online communities with shared interests rely on shared text-based chats, shared voice-based chats, shared activity “feeds,” and other social or “blog” style interactions between users. For example, with regard to sharing a particular piece of media content, an online community of participants may generate messages on a blog displaying that particular piece of media content.

Generally, these communities are ephemeral, and dissipate after a discussion related to the shared content ends. Accordingly, new pieces of related or desirable content must be uploaded, shared, or posted, and new communities must form about the newly shared content to maintain continuity of the user sharing content experience. These interactions with ephemeral groupings of users may detract from an immersive user sharing experience, and therefore may limit an amount of interaction for many users.

It is with respect to these and other considerations that the disclosure made herein is presented.

According to one implementation, a method of content sharing can include a step of determining a subgroup of users of a plurality of users associated with a common topic of interest. The subgroup of users may share the common topic of interest. Additionally, the determining can be facilitated through comparison of various user data to determine which users of the plurality of users share the common topic of interest.

The method can also include a step of identifying media content associated with the subgroup of users and the common topic of interest. For example, the identifying step can include searching a database of shareable content to determine media content associated with the common topic of interest. Thereafter, the method can include a step of causing a display of the shareable content to at least one user of the subgroup of users and receiving affirmation, or a confirmation, to display the shareable content. Alternatively, the identifying can also include searching a database of shareable content to determine media content associated with the common topic of interest and the contextual data associated with the subgroup of users.

The method can also include a step of generating a common user interface. The common user interface can be configured to cause computing devices to display the identified media content and communications between the subgroup of users and associated with the identified media content. Thereafter, the method can include sharing the common user interface with at least the subgroup of users. Accordingly, the subgroup of users can utilize the shared common user interface to interact with one another and view the identified media content. Thus, implementations of the method may overcome previous drawbacks by allowing a subgroup of users to interact with identified content related to a common topic of interest. The identified content can be periodically refreshed to establish additional opportunities for user interaction.

According to another implementation, a method of content sharing can include a step of determining a sub-group of user identities from a plurality of user identities. The sub-group of user identities can be associated with users having at least one common topic of interest. Additionally, the determining step can be facilitated through comparison of various user data to determine which users of the plurality of users share the common topic of interest.

The method can further include sharing media content across the sub-group of user identities and sharing chat content associated with the sub-group of user identities. The media content can be related to the common topic of interest. Furthermore, the chat content can include text, video, and/or audio information provided by individual users of the subgroup of user identities related to the currently shared media content.

Generally, the sharing of media content and chat content can be examined to determine an activity level or interest level in the presently shared media content and/or chat content. The method can also include a step of determining when activity associated with the media content or chat content is below a threshold. Thus, through examining the shared chat content the technologies disclosed herein can further determine when the shared media content should be refreshed or when new content should be shared to increase a level of interest in the content sharing platform.

Accordingly, in response to determining that the activity is below the threshold, the method can also include suggesting or automatically displaying new media content across the sub-group of user identities. The suggestion or automatic display can be based at least in part upon the at least one common topic of interest and contextual data for one or more user identities of the sub-group of user identities.

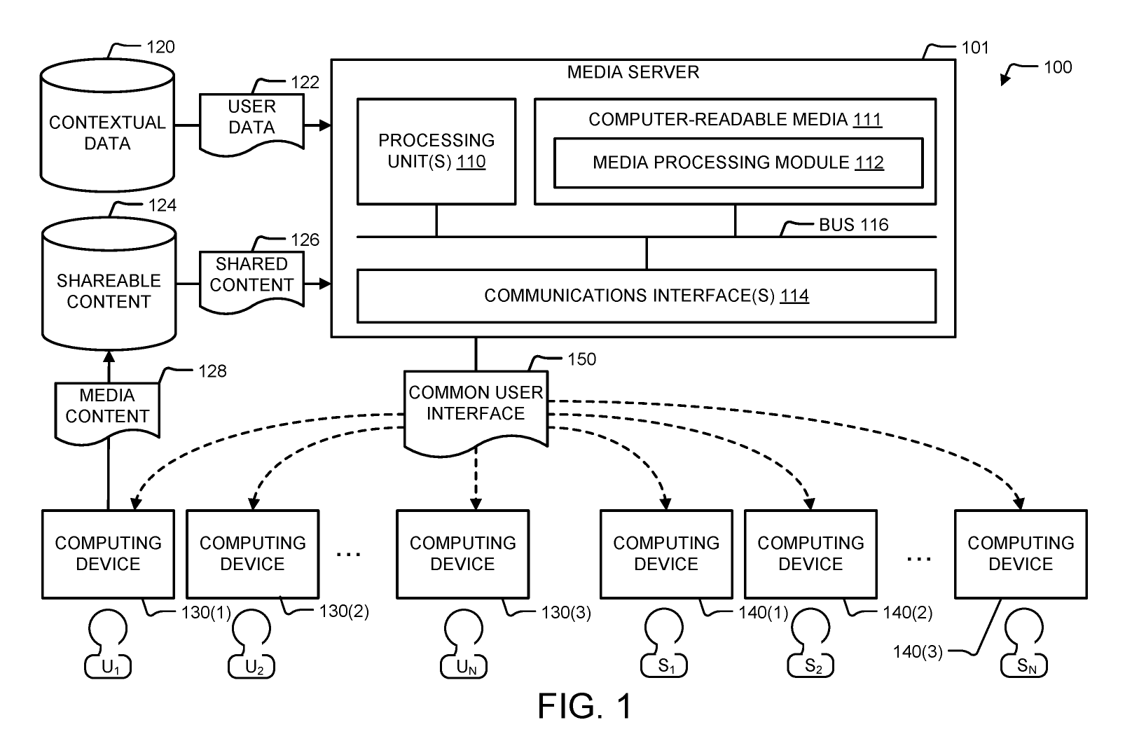

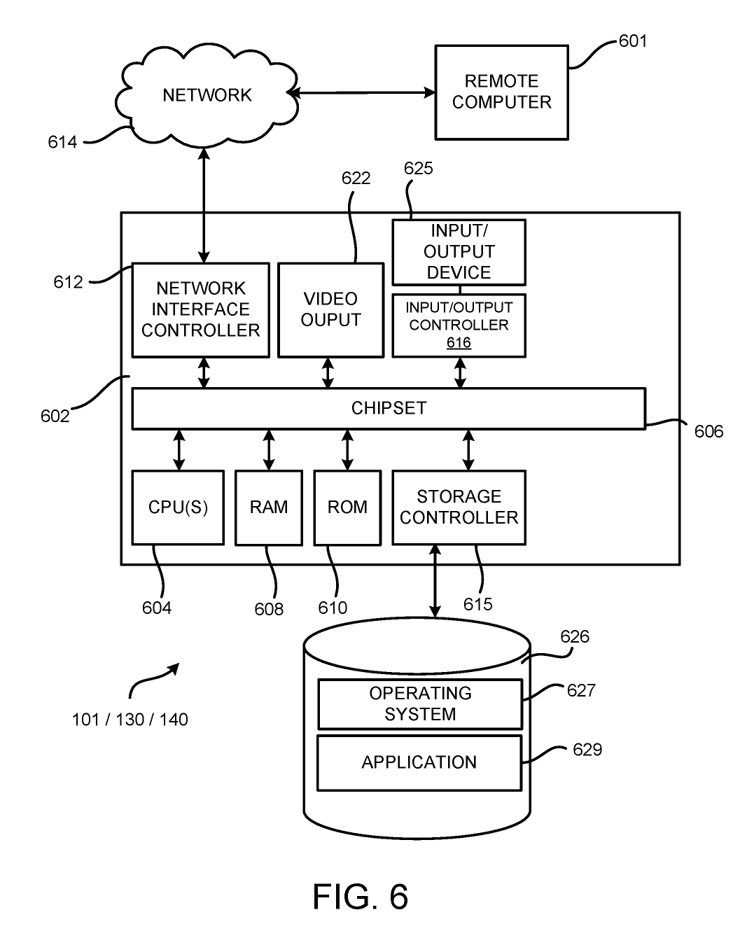

Turning now to the drawings, FIG. 1 is a diagram illustrating an example operating environment of system 100 to facilitate content sharing. The system 100 includes a media server 101 arranged to provide content sharing via a common user interface 150. The media server 101 may be a computing device arranged to distribute the common user interface 150. For example, the media server can comprise one or more processing units 110 configured to process data, computer readable storage media 111 in communication with the processing units 110 over bus 116 and configured to store data, and one or more communication interfaces 114 configured to distribute media and the common user interface 150. The media server 101 can also comprise a media processing module 112 configured to execute on the processing units 110 and direct the processing units 110 to perform computer-implemented methods of content sharing. A more detailed description of particular components related to the media server 101 and other suitable computing devices is provided below with reference to FIG. 6.

As shown in FIG. 1, the media server 101 is in communication with contextual data store 120. The contextual data store 120 is configured to store contextual data related to one or more user identities. For example, the contextual data store 120 can store and transmit user data 122 for the media server 101. The user data 122 can include any suitable information and data related to user identities, including but not limited to, user identity (User ID), topics of interest, prior engagement with one or more topics of interest, chat history, connected friends or associates, and other data useful in determining topics of interest.

The media server 101 can also be in communication with a shareable content store 124. The shareable content store 124 is configured to store media content 128 provided by one or more users of the system 100. For example, the shareable content store can store and transmit shared content 126 for the media server 101. As used herein, media content 128 and shared content 126 can refer to video, audio, text, graphics, images, and other forms of media data. The media content 128 may be associated with a particular user or computing device, and may be provided to the shareable content store 124 in some implementations. The shared content 126 may be content associated with a particular topic of interest and may be shared with the media server 101.

As further illustrated in FIG. 1, a plurality of users U₁, U₂, through U_{N} are associated with a plurality of computing devices 130(1), 130(2), through 130(3), respectively. Generally, the users U₁, U₂, through U_{N} can be referred to as “primary” or first users. The users U₁, U₂, through U_{N} can include any number of users, including groups of users or subgroups of users identified through the techniques described herein. As shown, the users U₁, U₂, through U_{N} utilize computing devices 130(1), 130(2), through 130(3) to access the common user interface 150 provided by the media server 101.

In general, the common user interface 150 is a platform-agnostic user interface capable of producing and reproducing a relevant, stable, and consistent user experience across a plurality of different computing platforms. In this manner, the common user interface 150 allows for any of the users of computing devices 130(1), 130(2), through 130(3) to consume the shared content 126 and interact between the users U₁, U₂, through U_{N}. Interactions can be facilitated through chatting, exchange of message postings and replies, and other communications. Furthermore, these communications may be displayed through the common user interface 150 such that any of the users U₁, U₂, through U_{N} can view and interact with the presently active users.

As further shown, a plurality of users S₁, S₂, through S_{N} are associated with a plurality of computing devices 140(1), 140(2), through 140(3), respectively. Generally, the users S₁, S₂, through S_{N} can be referred to as “secondary” or second users. The users S₁, S₂, through S_{N} can include any number of users, including groupings of users without a similar level of access as the primary users. As shown, the users S₁, S₂, through S_{N} utilize computing devices 140(1), 140(2), through 140(3) to access the common user interface 150 provided by the media server 101. However, in comparison with the interactions described above with regard to the primary users U₁, U₂, through U_{N}, the secondary users S₁, S₂, through S_{N} generally only receive viewing privileges for any shared media content and cannot directly interact with other users via the common user interface 150. Alternatively, in some implementations, a limited or “public” interaction methodology can be implemented to allow somewhat limited communication between users.

Thus, the system 100 facilitates content sharing across a plurality of computing devices through distribution of a common user interface 150 that allows shared content 126 to be displayed and utilized by a plurality of users. The shared content 126 can be chosen by primary users or can be chosen by the media server 101.

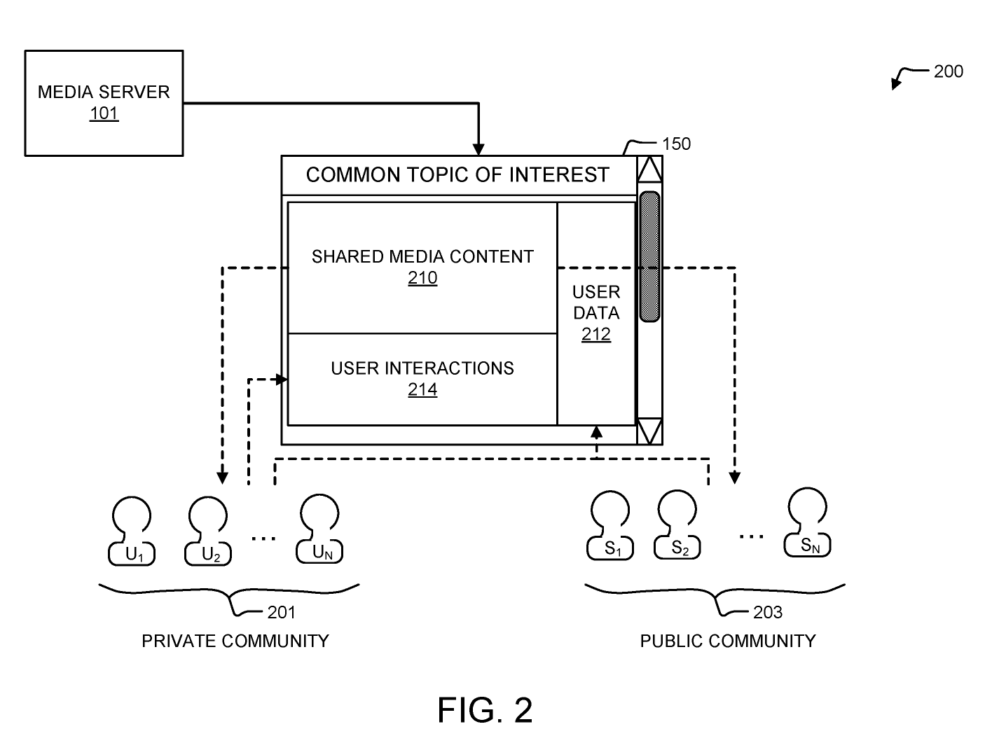

Hereinafter, a more detailed discussion of the operation of the system 100 with regard to different forms of users and media content is provided with reference to FIG. 2. FIG. 2 is a diagram illustrating an example operating environment of system 200 in which one or more groupings of users can receive and interact with shared content. Generally, the system 200 is substantially similar to the system 100, and can include all components not particularly illustrated.

As shown, the media server 101 can generate the common user interface 150. The common user interface 150 may be arranged as a user interface consumable and executable by a plurality of computing platforms. Thus, the common user interface 150 can be termed a “platform-agnostic” user interface configured to be executed by a plurality of computer systems in a stable and consistent manner. The common user interface 150 can be served or otherwise distributed by the media server 101 directly, or can be configured at a social networking website or other website for access by a plurality of computing devices. Furthermore, the common user interface 150 can be a streaming-based service user interface provided on the fly by the media server 101 or by a streaming service such as MIXER. Even further, the common user interface 150 may comprise a set of easily translated graphical elements that can be translated on the fly to be transmitted to a plurality of computing devices. As shown in FIG. 2, the common user interface 150 can be distributed to, or accessed by, both a private community of users 201 and a public community of users 203. Other forms of the common user interface 150 may also be applicable, and all such modifications and variations are within the scope of this disclosure.

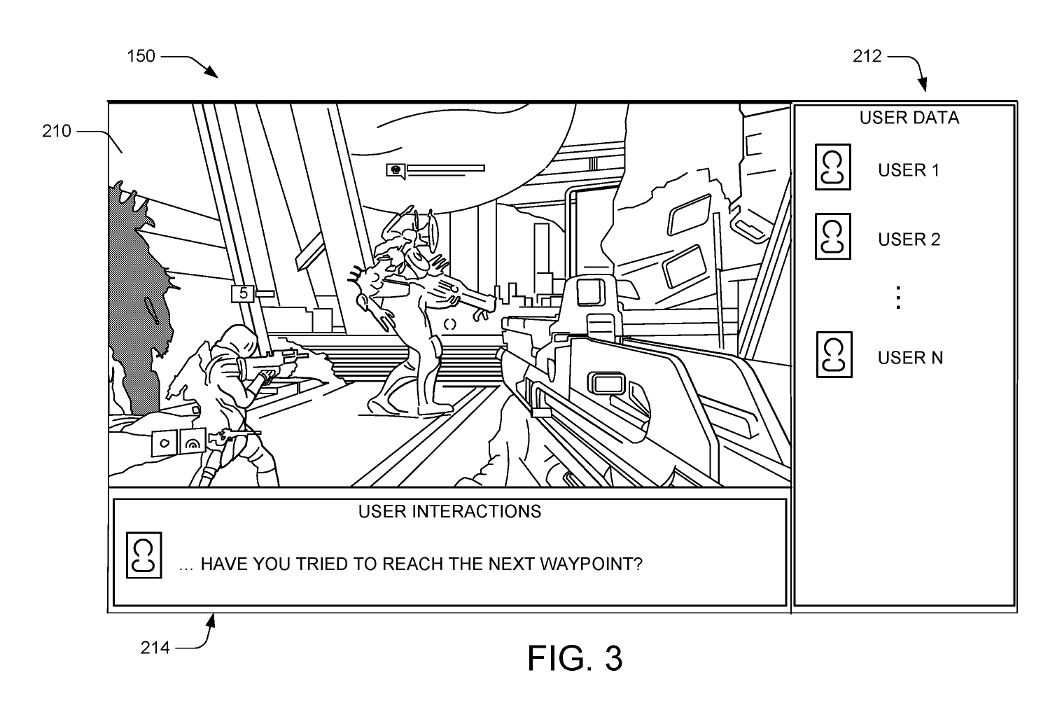

Turning to FIG. 3, the common user interface 150 comprises shared media content pane 210 configured to display shared content 126. The shared media content pane 210 can be sized according to any desirable aesthetics, and will generally comprise at least a graphical pane that allows the streaming or viewing of the shared content 126. The shared media content pane 210 may be accessible by the private community of users 201, which include the subgroup of users sharing a common topic of interest. The shared content pane 210 may also be accessible by the public community of users 203, which may or may not share the common topic of interest. For example, the private community of users 201 may comprise primary users while the public community of users 203 may comprise secondary users.

The common user interface further comprises user interactions pane 214 configured to display textual, graphical, and other information related to interactions between users in the private community of users 201. The user interactions pane 214 can be sized according to any desirable aesthetics, and will generally comprise at least a graphical pane that allows the sequential or simultaneous display of one or more user interactions related to the shared content 126. The user interactions pane 214 is generally only accessible to the private community of users 201, such that users of the private community of users can interact amongst other users sharing the common topic of interest.

The common user interface 150 further comprises user data pane 212 configured to display textual, graphical, and other information related to users accessing the common user interface 150. For example, the user data pane 212 can display information related to the private community of users 201 and the public community of users 203. In other implementations, the user data pane 212 can display information related only to the private community of users 201. In some implementations, particular users of the public community of users 203 may have data displayed at the user data pane 212 if, for example, they are actively viewing the shared content 126 or are requesting placement within the private community of users 201. Many other variations on the size, placement, and operation of each of the panes described above may also be applicable. All such variations are within the scope of this disclosure.

Thus, as described above with reference to FIG. 1, FIG. 2, and FIG. 3, systems 100 and 200 may facilitate sharing of content across a plurality of users using a novel common user interface 150. At least a subgroup of users (e.g., users 201) may share a common topic of interest and may interact with one another via the common user interface 150. The common user interface 150 is platform-agnostic, and facilitates an immersive, stable, and consistent user experience across a plurality of computing platforms (e.g., computing devices 130 and 140).

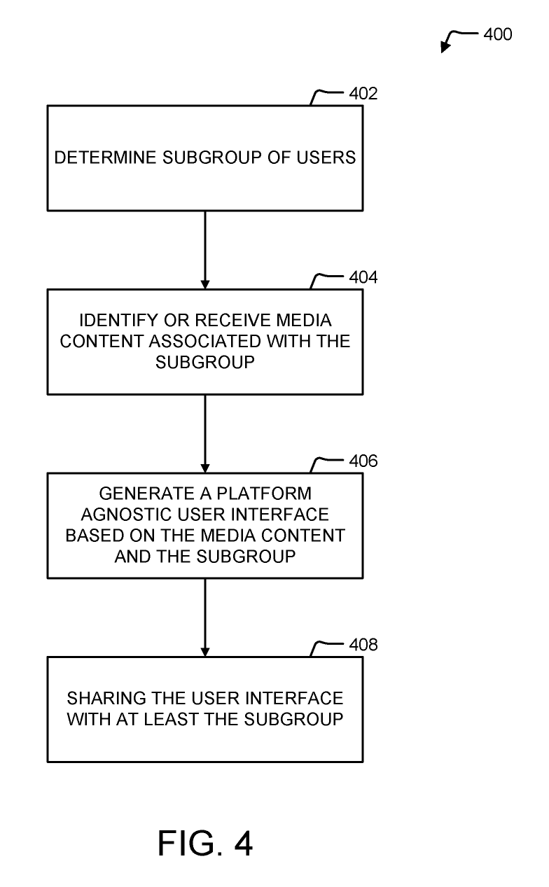

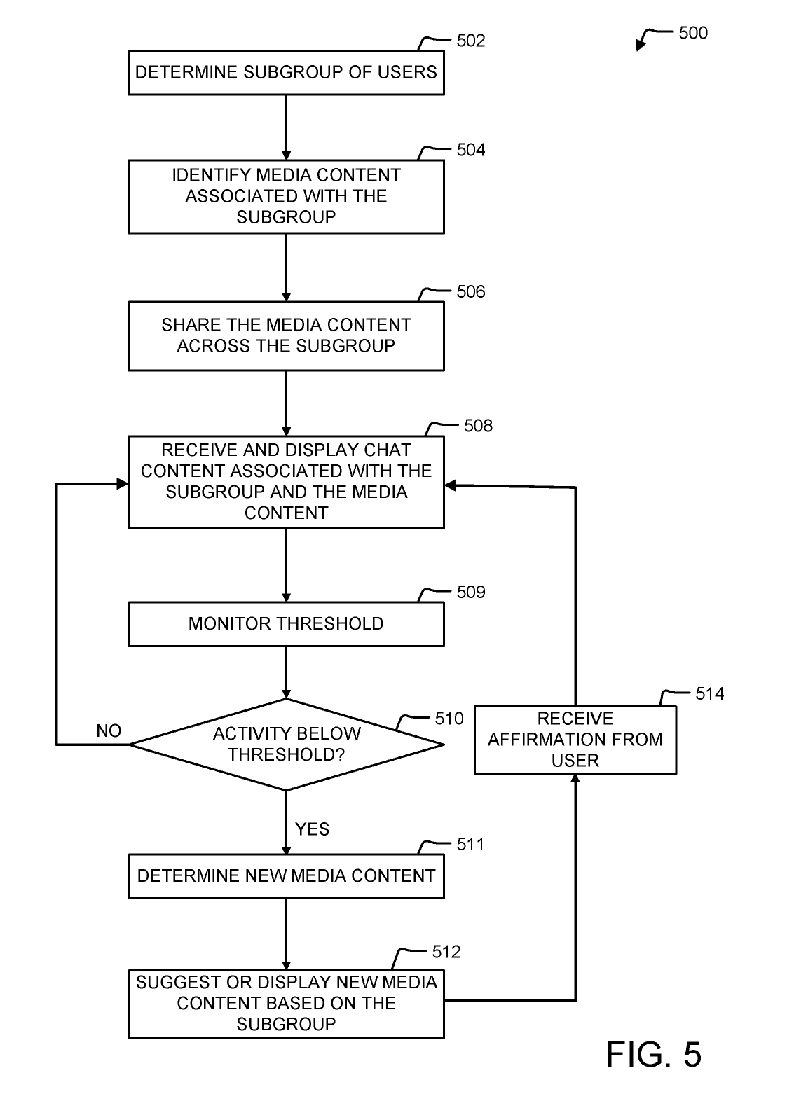

Hereinafter, a more detailed discussion of the operation of the systems and components described above is provided with reference to several flow diagrams. As illustrated in FIG. 4 and FIG. 5, aspects of methods 400 and 500 for providing content sharing are shown and described. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented in various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the methods 400 and 500 are described herein as being implemented, at least in part, by system components, which can comprise an application, component and/or a circuit. In some configurations, the system components include a dynamically linked library (DLL), a statically linked library, functionality produced by an application programing interface (API), a compiled program, an interpreted program, a script or any other executable set of instructions. Data, such as user data 122 and other data, can be stored in a data structure in one or more memory components. Data can be retrieved from the data structure by addressing links or references to the data structure.

Although the following illustration refers to the components of FIG. 1 and FIG. 2, it can be appreciated that the operations of the methods 400 and 500 may be also implemented in many other ways. For example, the methods 400 and 500 may be implemented, at least in part, by a processor of another remote computer or a local circuit. In addition, one or more of the operations of the methods 400 and 500 may alternatively or additionally be implemented, at least in part, by a chipset working alone or in conjunction with other software modules. Any service, circuit or application suitable for providing the techniques disclosed herein can be used in operations described herein.

FIG. 4 is a flow diagram of a method 400 for providing content sharing between subgroups of users, according to the techniques and technologies disclosed herein. For example, the method 400 can be performed by the media server 101 and/or the media processing module 112, in some implementations. As shown, the media server 101 determines a subgroup of users of a plurality of users associated with a common topic of interest, at block 402. In this implementation, the subgroup of users can be the private community of users 201. In other implementations, the subgroup of users may be users not included within the private community of users 201. The media server 101 can identify the subgroup of users by accessing the contextual data store 120 to retrieve user data 122.

The media server 101 can also identify media content associated with the subgroup of users and the common topic of interest, at block 404. For example, the media server 101 can access the shareable content store 124 to identify the media content, including shared content 126.

Thereafter, the media server 101 can generate the common user interface 150, at block 406. The common user interface can cause computing devices 130 and 140 to display the identified media content 126 and communications between the subgroup of users. Upon generation of the common user interface 150, the media server 101 can share the common user interface 150 with at least the subgroup of users, at block 408. Additionally, the media server 101 can share the common user interface with the public community of users 203, and in some cases a portion of the public community of users 203.

Generally, the media server 101 can determine the subgroup of users in a variety of manners. According to one implementation, the media server 101 can identify the common topic of interest from an existing grouping of users, and determine one or more additional users from a user database based on the identified common topic of interest. In this scenario, the media server 101 first identifies a common topic of interest amongst an existing subgroup, and then adds new users to the subgroup based on the identified common topic of interest.

In another implementation, the media server 101 can receive invitation data from an existing grouping of users, and transmit the invitation data to associated users of the plurality of users. In this manner, the media server 101 can indirectly identify the subgroup of users through an invitation received from users of an existing subgroup of users. This may increase the odds of all new users sharing the common topic of interest, or may allow increased privacy in some circumstances (e.g., invitation-only access to the common user interface 150).

Furthermore, it is noted that while users can submit invitation data to the media server for choosing additional users for the subgroup of users, the users may also submit media content to share at the common user interface, as well. For example, the media server 101 can search a database 124 of shareable content to determine media content associated with the identified common topic of interest. Thereafter, the media server 101 can suggest display of the shareable content 126 to at least one user of the subgroup of users and receive affirmation, e.g., a confirmation by one or more users, to display the shareable content. In this manner, the media server 101 receives feedback prior to altering the shared content displayed at the shared content pane 210 of the common user interface 150.

Alternatively, the media server 101 can also immediately push new content onto the common user interface 150, if desirable. For example, the media server 101 can search a database 124 of shareable content to determine media content associated with the common topic of interest and the contextual data associated with the subgroup of users. Thereafter, the media server 101 can cause the shared content 126 to be rendered on the common user interface 150.

With regard to the contextual information utilized by the media server 101, it should be understood that a plurality of forms of contextual data are applicable. For example, the contextual data can comprise at least one attribute selected from the group consisting of social media signals, user profile data, and user share history data. The social media signals can include any form of social media contextual data, including interactions, “likes,” acknowledged topics of interest, and other data. User profile data can include any form of user data including geographical location, usage history, and other user profile data. Additionally, user share history data can include a history of topics and content shared by a particular user. Thus, using the contextual data, the media server 101 can appropriately determine new media to share or new media to suggest sharing.

When generating the common user interface 150, the media server can generate a media share portion or pane 210 of the common user interface 150. As discussed above, the media share portion or pane 210 comprises a graphical area for display of the identified media content. Thereafter, the media server 101 can generate a user interactions pane 214 or communications share portion of the common user interface 150. The user interactions pane 214 comprises a graphical area for display of chat information between users of the subgroup of users. Additionally, the media server 101 can generate a user data pane 212 or share portion of the common user interface 150. The user data pane 212 or share portion comprises a graphical area for display of user profile data associated with users of the subgroup of users.

As described above, the media server 101 can generate the common user interface 150, and share the common user interface 150 amongst a plurality of users. Generally, the media server 101 can share the common user interface 150 through a network to one or more computing devices 130 and 140 associated with the subgroup of users. The media server 101 can also share the common user interface 150 through a social media network. Even further, the media server 101 can share the common user interface through a gaming social media network or a live streaming service for video games.

As further described above, at least limited access can be granted by the media server 101 to a public community of users 203. For example, the media server 101 can also share the common user interface 150 through a social media network to users other than the subgroup of users. In this scenario, the users other than the subgroup of users retain limited communication privileges with the subgroup of users via the common user interface 150.

In the alternative, the media server can also share the common user interface through a social media network to users other than the subgroup of users. In this example, the subgroup of users can retain unlimited communication privileges via the common user interface 150.

Thus, the media server 101 can determine a subgroup of users, identify media content associated with the subgroup of users, and generate a common user interface for distributing the identified media content to the subgroup of users. The media server 101 can also directly share media content on a variety of computing platforms based on activity levels and other thresholds.

FIG. 5 is a flow diagram of a method 500 for providing content sharing based on an activity threshold, according to the techniques and technologies disclosed herein. Generally, the method 500 can be performed by the media server 101 and/or the media processing module 112.

According to FIG. 5, the media server 101 can determine a sub-group of user identities from a plurality of user identities, at block 502. Generally, the sub-group of user identities are associated with users having at least one common topic of interest. Thereafter, the media server 101 can identify media content associated with the subgroup of user identities, at block 504. For example, the media server 101 can identify the shared media content 126 as described above.

Upon determining the media content to share, the media server 101 can share the media content across the sub-group of user identities, at block 506. In one implementation, the media content is shared via a social network or media streaming service. According to other implementations, the media content is shared via a common user interface 150.

Thereafter, the media server 101 can receive and display chat content associated with the sub-group of user identities and the media content, at block 508. In response to receiving and sharing chat content, the media server 101 can monitor an activity level threshold, at block 509. Generally, the activity level threshold is a predetermined or desired threshold of activity that can be quantified for determining whether new media content should be chosen. Thus, the media server 101 can also determine if activity associated with the media content or chat content is below a threshold, at block 510.

In response to determining that the activity is below the threshold, the media server 101 can determine new media content to suggest or display, at block 511. Upon determining the new media content, the media server 101 can suggest or automatically display the new media content across the sub-group of user identities, at block 512. Generally, the suggestion or automatic display is based at least upon the at least one common topic of interest and contextual data for one or more user identities of the sub-group of user identities. Furthermore, the media server can optionally receive affirmation or confirmation from a user to post suggested content, at block 514.

FIG. 6 shows additional details of an example computer architecture for the components shown in FIG. 1 and FIG. 2 capable of executing the program components described above. The computer architecture shown in FIG. 6 illustrates aspects of a system, such as a game console, conventional server computer, workstation, desktop computer, laptop, tablet, phablet, network appliance, personal digital assistant (“PDA”), e-reader, digital cellular phone, or other computing device, and may be utilized to execute any of the software components presented herein. For example, the computer architecture shown in FIG. 6 may be utilized to execute any of the software components described above. Although some of the components described herein are specific to the computing devices 101, 130, and 140, it can be appreciated that such components, and other components may be part of any suitable remote computer.

It should be understood that although described as a server computer, media server, and/or computer, the device 101 can take many forms. Computing devices 130 and 140 can also take similar forms. The device 101 includes a baseboard 602, or “motherboard,” which is a printed circuit board to which a multitude of components or devices may be connected by way of a system bus or other electrical communication paths. In one illustrative embodiment, one or more central processing units (“CPUs”) 604 operate in conjunction with a chipset 606. The CPUs 604 may be standard programmable processors that perform arithmetic and logical operations necessary for the operation of the device 101.

The CPUs 604 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 may provide an interface to a RAM 608, used as the main memory in the device 101. The chipset 606 may further provide an interface to a computer-readable storage medium such as a read-only memory (“ROM”) 610 or non-volatile RAM (“NVRAM”) for storing basic routines that help to startup the device 101 and to transfer information between the various components and devices. The ROM 610 or NVRAM may also store other software components necessary for the operation of the device 101 in accordance with the embodiments described herein.

The device 101 may operate in a networked environment using logical connections to remote computing devices and computer systems through a network 614, such as the local area network. The chipset 606 may include functionality for providing network connectivity through a network interface controller (NIC) 612, such as a gigabit Ethernet adapter. The NIC 612 is capable of connecting the device 101 to other computing devices over the network. It should be appreciated that multiple NICs 612 may be present in the device 101, connecting the computer to other types of networks and remote computer systems. The network allows the device 101 to communicate with remote services and servers, such as the remote computer 601. As can be appreciated, the remote computer 601 may host a number of services such as the XBOX LIVE gaming service provided by MICROSOFT CORPORATION of Redmond, Wash. In addition, as described above, the remote computer 801 may mirror and reflect data stored on the device 101 and host services that may provide data or processing for the techniques described herein.

The device 101 may be connected to a mass storage device 626 that provides non-volatile storage for the computing device. The mass storage device 626 may store system programs, application programs, other program modules, and data, which have been described in greater detail herein. The mass storage device 626 may be connected to the device 101 through a storage controller 615 connected to the chipset 606. The mass storage device 626 may consist of one or more physical storage units. The storage controller 615 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. It should also be appreciated that the mass storage device 626, other storage media and the storage controller 615 may include MultiMediaCard (MMC) components, eMMC components, Secure Digital (SD) components, PCI Express components, or the like.

The device 101 may store data on the mass storage device 626 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 626 is characterized as primary or secondary storage, and the like.

For example, the device 101 may store information to the mass storage device 626 by issuing instructions through the storage controller 615 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The device 101 may further read information from the mass storage device 626 by detecting the physical states or characteristics of one or more particular locations within the physical storage units.

In addition to the mass storage device 626 described above, the device 101 may have access to other computer-readable media to store and retrieve information, such as program modules, data structures, or other data. Thus, while the application 629, other data and other modules are depicted as data and software stored in the mass storage device 626, it should be appreciated that these components and/or other modules may be stored, at least in part, in other computer-readable storage media of the device 101. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the device 101.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the device 101. For purposes of the claims, the phrase “computer storage medium,” “computer-readable storage medium,” and variations thereof, does not include waves or signals per se and/or communication media.

The mass storage device 626 may store an operating system 627 utilized to control the operation of the device 101. According to one embodiment, the operating system comprises a gaming operating system. According to another embodiment, the operating system comprises the WINDOWS® operating system from MICROSOFT Corporation. According to further embodiments, the operating system may comprise the UNIX, ANDROID, WINDOWS PHONE or iOS operating systems, available from their respective manufacturers. It should be appreciated that other operating systems may also be utilized. The mass storage device 626 may store other system or application programs and data utilized by the device 101, such as any of the other software components and data described above. The mass storage device 626 might also store other programs and data not specifically identified herein.

In one embodiment, the mass storage device 626 or other computer-readable storage media is encoded with computer-executable instructions which, when loaded into the device 101, transform the computer from a general-purpose computing system into a special-purpose computer capable of implementing the embodiments described herein. These computer-executable instructions transform the device 101 by specifying how the CPUs 604 transition between states, as described above. According to one embodiment, the device 101 has access to computer-readable storage media storing computer-executable instructions which, when executed by the device 101, perform the various routines described above with regard to FIG. 4, FIG. 5, and the other FIGURES. The device 101 might also include computer-readable storage media for performing any of the other computer-implemented operations described herein.

The device 101 may also include one or more input/output controllers 616 for receiving and processing input from a number of input devices, such as a keyboard, a mouse, a microphone, a headset, a touchpad, a touch screen, an electronic stylus, or any other type of input device. Also shown, the input/output controller 616 is in communication with an input/output device 625. The input/output controller 616 may provide output to a display, such as a computer monitor, a flat-panel display, a digital projector, a printer, a plotter, or other type of output device. The input/output controller 616 may provide input communication with other devices such as a microphone, a speaker, game controllers and/or audio devices.

In addition, or alternatively, a video output 622 may be in communication with the chipset 606 and operate independently from the input/output controllers 616. It will be appreciated that the device 101 may not include all of the components shown in FIG. 6, may include other components that are not explicitly shown in FIG. 6, or may utilize an architecture completely different than that shown in FIG. 6.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The present disclosure is made in light of the following examples:

### Example 1

A computer-implemented method, comprising: determining (402) a subgroup of users of a plurality of users associated with a common topic of interest; identifying (404) media content associated with the subgroup of users and the common topic of interest; generating (406) a common user interface (150), the common user interface used to cause computing devices (130) to display the identified media content and communications between the subgroup of users and associated with the identified media content; and sharing (408) the common user interface (150) with at least the subgroup of users.

### Example 2

The computer-implemented method as in example 1, wherein determining the subgroup of users comprises: identifying the common topic of interest from an existing grouping of users; and determining one or more additional users from a user database based on the identified common topic of interest.

### Example 3

The computer-implemented method as in example 1, wherein determining the subgroup of users comprises: receiving invitation data from an existing grouping of users; and transmitting the invitation data to associated users of the plurality of users.

### Example 4

The computer-implemented method as in example 1, wherein identifying media content comprises: searching a database of shareable content to determine media content associated with the common topic of interest; causing a display of the shareable content to at least one user of the subgroup of users; and receiving affirmation to display the shareable content.

### Example 5

The computer-implemented method as in example 1, wherein identifying media content comprises: searching a database of shareable content to determine media content associated with the common topic of interest and the contextual data associated with the subgroup of users.

### Example 6

The computer-implemented method as in example 5, wherein the contextual data comprises at least one of social media signals, user profile data, or user share history data.

### Example 7

The computer-implemented method as in example 1, wherein generating the common user interface comprises: generating a media share portion of the common user interface, wherein the media share portion comprises a graphical area for display of the identified media content; and generating a communications share portion of the common user interface, wherein the communications share portion comprises a graphical area for display of chat information between users of the subgroup of users.

### Example 8

The computer-implemented method as in example 7, wherein generating the common user interface further comprises: generating a user data share portion of the common user interface, wherein the user data share portion comprises a graphical area for display of user profile data associated with users of the subgroup of users.

### Example 9

The computer-implemented method as in example 1, wherein sharing the common user interface comprises: sharing the common user interface through a network to one or more computing devices associated with the subgroup of users.

### Example 10

The computer-implemented method as in example 1, wherein sharing the common user interface comprises: sharing the common user interface through a social media network.

### Example 11

The computer-implemented method as in example 10, wherein the social media network is a gaming social media network or a live streaming service for video games.

### Example 12

The computer-implemented method as in example 1, further comprising: sharing the common user interface through a social media network to users other than the subgroup of users, wherein the users other than the subgroup of users retain limited communication privileges with the subgroup of users via the common user interface.

### Example 13

The computer-implemented method as in example 1, further comprising: sharing the common user interface through a social media network to users other than the subgroup of users, wherein the subgroup of users retain unlimited communication privileges via the common user interface.

### Example 14

The computer-implemented method as in example 1, further comprising: receiving a request to share first media content from at least one user of the subgroup of users; and generating the common user interface to include a rendering of the first media content.

### Example 15

A computing device, comprising: a processor (604); a memory (608) having computer-executable instructions stored thereupon which, when executed by the processor (604), cause the computing device to determine (402) a subgroup of users of a plurality of users associated with a common topic of interest; identify (404) media content associated with the subgroup of users and the common topic of interest; generate (406) a common user interface (150), the common user interface (150) used to cause computing devices to display the identified media content and communications between the subgroup of users and associated with the identified media content; and share (408) the common user interface with at least the subgroup of users.

### Example 16

The computing device as in example 15, wherein determining the subgroup of users comprises: identifying the common topic of interest from an existing grouping of users; and determining one or more additional users from a user database based on the identified common topic of interest.

### Example 17

The computing device as in example 15, wherein determining the subgroup of users comprises: receiving invitation data from an existing grouping of users; and transmitting the invitation data to associated users of the plurality of users.

### Example 18

The computing device as in example 15, wherein identifying media content comprises: searching a database of shareable content to determine media content associated with the common topic of interest; causing a display of the shareable content to at least one user of the subgroup of users; and receiving affirmation to display the shareable content.

### Example 19

A system, comprising: a processor (604); a memory (608) having computer-executable instructions stored thereupon which, when executed by the processor (604), cause the system to determine (402) a subgroup of users of a plurality of users associated with a common topic of interest; identify (404) media content associated with the subgroup of users and the common topic of interest; generate (406) a common user interface (150), the common user interface (150) used to cause computing devices to display the identified media content and communications between the subgroup of users and associated with the identified media content; and share (408) the common user interface (150) with at least the subgroup of users.

### Example 20

The system as in example 19, wherein determining the subgroup of users comprises: identifying the common topic of interest from an existing grouping of users; and determining one or more additional users from a user database based on the identified common topic of interest.

### Example 21

The system as in example 19, wherein determining the subgroup of users comprises: receiving invitation data from an existing grouping of users; and transmitting the invitation data to associated users of the plurality of users.

### Example 22

The system as in example 19, wherein identifying media content comprises: searching a database of shareable content to determine media content associated with the common topic of interest; causing a display of the shareable content to at least one user of the subgroup of users; and receiving affirmation to display the shareable content.

### Example 23

The system as in example 19, wherein identifying media content comprises: searching a database of shareable content to determine media content associated with the common topic of interest and the contextual data associated with the subgroup of users.

### Example 24

The system as in example 23, wherein the contextual data comprises at least one of social media signals, user profile data, or user share history data.

### Example 25

The system as in example 19, wherein generating the common user interface comprises: generating a media share portion of the common user interface, wherein the media share portion comprises a graphical area for display of the identified media content; and generating a communications share portion of the common user interface, wherein the communications share portion comprises a graphical area for display of chat information between users of the subgroup of users.

### Example 26

A computer-implemented method, comprising: determining (502) a sub-group of user identities from a plurality of user identities, wherein the sub-group of user identities are associated with users having at least one common topic of interest; sharing (506) media content across the sub-group of user identities; sharing (508) chat content associated with the sub-group of user identities; determining (510) that activity associated with the media content or chat content is below a threshold; in response to determining that the activity is below the threshold, automatically displaying (512) new media content across the sub-group of user identities, wherein the suggestion or automatic display is based at least upon the at least one common topic of interest and contextual data for one or more user identities of the sub-group of user identities.

### Example 27

The computer-implemented method as in example 26, wherein determining the subgroup of user identities comprises: identifying the common topic of interest from an existing grouping of user identities; and determining one or more additional user identities from a user database based on the identified common topic of interest.

### Example 28

The computer-implemented method as in example 26, wherein determining the subgroup of user identities comprises: receiving invitation data from an existing grouping of user identities; and transmitting the invitation data to associated user identities of the plurality of user identities.

### Example 29

The computer-implemented method as in example 26, wherein identifying media content comprises: searching a database of shareable content to determine media content associated with the common topic of interest; causing a display of the shareable content to at least one user identity of the subgroup of user identities; and receiving affirmation to display the shareable content.

### Example 30

The computer-implemented method as in example 26, wherein sharing media content comprises: searching a database of shareable content to determine media content associated with the common topic of interest and contextual data associated with the subgroup of users; and sharing the determined media content.

### Example 31

A computer-implemented method, comprising: determining (402) a subgroup of users of a plurality of users associated with a common topic of interest; generating a common user interface (150), the common user interface (150) used to cause computing devices to display media content and communications between the subgroup of users; receiving (404) media content from at least one user of the subgroup of users, wherein the media content is associated with the common topic of interest; and sharing (408) the common user interface (150) and received media content with at least the subgroup of users.

### Example 32

The computer-implemented method as in example 31, further comprising: receiving new media content from the at least one user of the subgroup of users, wherein the new media content is associated with the common topic of interest; and refreshing the common user interface to cause a rendering of the new media content.

What is claimed is:

1. A computer-implemented method, comprising:
determining a subgroup of users of a plurality of users associated with a common topic of interest;
identifying media content associated with the subgroup of users and the common topic of interest;
generating a common user interface, the common user interface used to cause computing devices to display the identified media content and communications between the subgroup of users and associated with the identified media content; and
sharing the common user interface with at least the subgroup of users.

2. The computer-implemented method of claim 1, wherein determining the subgroup of users comprises:
identifying the common topic of interest from an existing grouping of users; and
determining one or more additional users from a user database based on the identified common topic of interest.

3. The computer-implemented method of claim 1, wherein determining the subgroup of users comprises:
receiving invitation data from an existing grouping of users; and
transmitting the invitation data to associated users of the plurality of users.

4. The computer-implemented method of claim 1, wherein identifying media content comprises:
searching a database of shareable content to determine media content associated with the common topic of interest;
causing a display of the shareable content to at least one user of the subgroup of users; and
receiving affirmation to display the shareable content.

5. The computer-implemented method of claim 1, wherein identifying media content comprises:
searching a database of shareable content to determine media content associated with the common topic of interest and the contextual data associated with the subgroup of users.

6. The computer-implemented method of claim 5, wherein the contextual data comprises at least one of social media signals, user profile data, or user share history data.

7. The computer-implemented method of claim 1, wherein generating the common user interface comprises:
generating a media share portion of the common user interface, wherein the media share portion comprises a graphical area for display of the identified media content; and
generating a communications share portion of the common user interface, wherein the communications share portion comprises a graphical area for display of chat information between users of the subgroup of users.

8. The computer-implemented method of claim 7, wherein generating the common user interface further comprises:
generating a user data share portion of the common user interface, wherein the user data share portion comprises a graphical area for display of user profile data associated with users of the subgroup of users.

9. The computer-implemented method of claim 1, wherein sharing the common user interface comprises:
sharing the common user interface through a network to one or more computing devices associated with the subgroup of users.

10. The computer-implemented method of claim 1, wherein sharing the common user interface comprises:
sharing the common user interface through a social media network.

11. The computer-implemented method of claim 10, wherein the social media network is a gaming social media network or a live streaming service for video games.

12. The computer-implemented method of claim 1, further comprising:
sharing the common user interface through a social media network to users other than the subgroup of users, wherein the users other than the subgroup of users retain limited communication privileges with the subgroup of users via the common user interface.

13. The computer-implemented method of claim 1, further comprising:
sharing the common user interface through a social media network to users other than the subgroup of users, wherein the subgroup of users retain unlimited communication privileges via the common user interface.

14. The computer-implemented method of claim 1, further comprising:
receiving a request to share first media content from at least one user of the subgroup of users; and
generating the common user interface to include a rendering of the first media content.

15. A computing device, comprising:
a processor;
a memory having computer-executable instructions stored thereupon which, when executed by the processor, cause the computing device to
determine a subgroup of users of a plurality of users associated with a common topic of interest;
identify media content associated with the subgroup of users and the common topic of interest;
generate a common user interface, the common user interface used to cause computing devices to display the identified media content and communications between the subgroup of users and associated with the identified media content; and
share the common user interface with at least the subgroup of users.

16. The computing device of claim 15, wherein determining the subgroup of users comprises:
identifying the common topic of interest from an existing grouping of users; and
determining one or more additional users from a user database based on the identified common topic of interest.

17. The computing device of claim 15, wherein determining the subgroup of users comprises:
receiving invitation data from an existing grouping of users; and
transmitting the invitation data to associated users of the plurality of users.

18. The computing device of claim 15, wherein identifying media content comprises:
searching a database of shareable content to determine media content associated with the common topic of interest;
causing a display of the shareable content to at least one user of the subgroup of users; and
receiving affirmation to display the shareable content.

19. A system, comprising:
a processor;
a memory having computer-executable instructions stored thereupon which, when executed by the processor, cause the system to
determine a subgroup of users of a plurality of users associated with a common topic of interest;
identify media content associated with the subgroup of users and the common topic of interest;
generate a common user interface, the common user interface used to cause computing devices to display the identified media content and communications between the subgroup of users and associated with the identified media content; and
share the common user interface with at least the subgroup of users.

20. The system of claim 19, wherein determining the subgroup of users comprises:
identifying the common topic of interest from an existing grouping of users; and
determining one or more additional users from a user database based on the identified common topic of interest.
